(19) United States
(12) Patent Application Publication
(10) Pub. No.: US 2018/0109809 A1
(43) Pub. Date: Apr. 19, 2018

(54) VOXEL VIDEO CODING

(71) Applicant: GOOGLE LLC, Mountain View, CA (US)

(72) Inventor: Pawin Vongmasa, Mountain View, CA (US)

(21) Appl. No.: 15/730,861

(22) Filed: Oct. 12, 2017

Related U.S. Application Data
(60) Provisional application No. 62/407,645, filed on Oct. 13, 2016.

(51) Int. Cl. H04N 19/61; H04N 19/176; H04N 19/105; H04N 19/107; H04N 19/13; H04N 19/513

(52) U.S. Cl. CPC H04N 19/61; H04N 19/176; H04N 19/513; H04N 19/107; H04N 19/13; H04N 19/105

(57) ABSTRACT

Techniques are described to decode an encoded video bitstream. One method includes receiving an encoded bitstream representative of video data including a block having a temporal dimension and a plurality of pieces defining a boundary of the block; entropy decoding, from the encoded bitstream, a residual for the current piece of the block; determining, for a current piece, at least one of a first prediction piece and a second prediction piece, wherein the first prediction piece is determined based on a reference to a previously decoded piece, and the second prediction piece is determined based on solving a linear system associated with coefficients for the current piece and previously decoded pixels associated with a boundary of the current piece; and determining a reconstructed piece for the current piece of the block based on the residual and the at least one of the first prediction piece and the second prediction piece.

### CROSS-REFERENCE TO RELATED APPLICATION(S)

This application claims priority to U.S. Provisional Application No. 62/407,645 filed on Oct. 13, 2016, the content of which is hereby incorporated by reference in its entirety.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission or storage of the video data. Various approaches have been proposed to reduce the amount of data in video streams, including compression and other encoding techniques.

### SUMMARY

This disclosure relates generally to encoding and decoding video data.

An aspect is a method for decoding a video bitstream. The method includes receiving an encoded bitstream representative of a video signal including a block having a plurality of pieces defining a boundary of the block, the plurality of pieces comprising a current piece; entropy decoding, from the encoded bitstream, a residual for the current piece of the block; determining, for the current piece of the block using a processor, at least one of a first prediction piece or a second prediction piece, wherein the first prediction piece is determined based on a reference to a previously decoded piece, and the second prediction piece is determined based on solving a linear system associated with coefficients for the current piece and previously decoded pixels associated with a boundary of the current piece; and determining a reconstructed piece for the current piece of the block based on the residual and the at least one of the first prediction piece and the second prediction piece. In some implementations, the block has a temporal dimension.

Another aspect is a method for encoding video data. The method includes determining, for a current piece of a block of the video data using a processor, at least one of a first prediction piece or a second prediction piece, the block having a plurality of pieces defining a boundary of the block, the plurality of pieces comprising the current piece, wherein the first prediction piece is determined based on a reference to a previously encoded piece of the video data, and the second prediction piece is determined based on solving a linear system associated with coefficients for the current piece and previously encoded pixels associated with a boundary of the current piece; determining a residual for the current piece of the block based on the current piece and the at least one of the first prediction piece or the second prediction piece; and entropy encoding the residual for the current piece of the block into a video bitstream. In some implementations, the block has a temporal dimension.

Another aspect is an apparatus for decoding video data. The apparatus includes a non-transitory memory and a processor. The non-transitory memory includes instructions executable by the processor to receive an encoded bitstream being representative of video data, the video data comprising a block having a temporal dimension and a plurality of pieces defining a boundary of the block, the plurality of pieces comprising a current piece; entropy decode, from the encoded bitstream, a residual for the current piece of the block; determine, for the current piece of the block, at least one of a first prediction piece or a second prediction piece, wherein the first prediction piece is determined based on a reference to a previously decoded piece, and the second prediction piece is determined based on solving a linear system associated with coefficients for the current piece and previously decoded pixels associated with a boundary of the current piece; and determine a reconstructed piece for the current piece of the block based on the residual and the at least one of the first prediction piece or the second prediction piece.

Variations in these and other aspects of the disclosure will be described in additional detail hereafter.

### BRIEF DESCRIPTION OF THE DRAWINGS

The description herein makes reference to the accompanying drawings wherein like reference numerals refer to like parts throughout the several views.

FIG. 1 is a schematic of a video encoding and decoding system in accordance with implementations of this disclosure;

FIG. 2 is a block diagram of an example of a computing device that can implement a transmitting station or a receiving station in accordance with implementations of this disclosure;

FIG. 3 is a block diagram of a decoder that can be used for voxel video coding in accordance with implementations of this disclosure;

FIG. 4 is a flow diagram of an example decoding process of a video stream in accordance with implementations of this disclosure;

FIG. 5 shows an example voxel video coding unit in accordance with implementations of this disclosure; and

FIG. 6 is a block diagram of an encoder that can be used for voxel video coding in accordance with implementations of this disclosure.

### DETAILED DESCRIPTION

Compression schemes related to coding video streams may include breaking each image into blocks and generating a digital video output bitstream using one or more techniques to limit the information included in the output. A received bitstream can be decoded to re-create the blocks and the source images from the limited information. Encoding a video stream, or a portion thereof, can include using temporal and spatial similarities in the video stream to improve coding efficiency. Because human visual perception is not perfect, lossy compression can be used to compress video data. For example, since human eyes tend to be less sensitive to small features in an image (e.g., features with high spatial frequency and low amplitude), a Fourier-type two-dimensional transform can be used in conventional codecs to obtain a representation of an image in the frequency domain.

As growth of computing technology allows faster and more complex computations within a reasonable amount of time, a video codec of higher complexity can be implemented to achieve higher compression ratio. According to implementations of this disclosure, voxel video codec is designed to take into account the temporal dimension in addition to the two spatial dimensions, making use of a Fourier-type three-dimensional transform. Based on the assumption that human eyes also tend to be less sensitive to small features in time (e.g., features with high temporal frequency and low amplitude), voxel video codec can be designed to achieve higher compression ratio than the conventional codecs.

According to implementations of this disclosure, a video stream can be considered as one voxel image. This point of view allows exploitation of more temporal correlation in the voxel video codec than the conventional codecs. The voxel image can be divided by an encoder into three-dimensional blocks, also referred to herein as “macroblocks” or “voxel blocks”. A macroblock can be, for example, a three-dimensional block having a temporal dimension. Unless otherwise noted, the term “block” can refer to a macroblock, a subblock (i.e., a subdivision of a macroblock), a segment, a slice, a residual block or any other three-dimensional portion of a video stream. The block can also include a multi-dimensional macroblock with more than three dimensions. The coding of a block can be processed by coding a number of “pieces” for the block (“piece coding”). A “piece” can refer to the block. The piece can also refer to a face, an edge, or a point, any or a combination of which can be used to define a boundary of the block. The decoding order of the pieces can be specified by the encoder. For example, the decoding order of the pieces can be specified at the block level, or at the bitstream level (applicable to some or all of the blocks). The decoding order can also be predetermined or inferred from the bitstream.

Because the nature of the temporal dimension is very different from the two spatial dimensions, voxel video codec can have a coding unit (e.g., a block) with varying length (also referred to herein as “depth”) of the temporal dimension. For example, at twenty-four frames per second, a five-second scene from the video stream can have a depth of one hundred and twenty.

According to some implementations, at least two types of prediction are used: “jump prediction”, and “fill prediction”. Jump prediction can be used to form a prediction piece based on a reference to a previously decoded piece. Fill prediction can be used to form a prediction piece based on, for example, solving a linear system (e.g., solving an affine equation) associated with coefficients determined for a piece and previously decoded pixels associated with a boundary of the piece. For the fill prediction, the prediction piece can also be determined, for example, based other types of relationships between the coefficients determined for the piece and previously decoded pixels associated with a boundary of the piece.

A piece can be predicted using either or both of jump prediction and fill prediction, the two prediction types described above. When both prediction types are used for the piece, a sum of the prediction pieces resulted from using jump prediction and fill prediction can be used as the prediction piece. The prediction piece is then subtracted from the piece to from a residual, which can be transformed and entropy coded. At the decoder, the residual is decoded for the piece from the bitstream (e.g., by entropy decoding followed by inverse transform), and the decoded residual is added to the prediction piece to generate a reconstructed piece. Other details are described herein after first describing an environment in which the disclosure may be implemented.

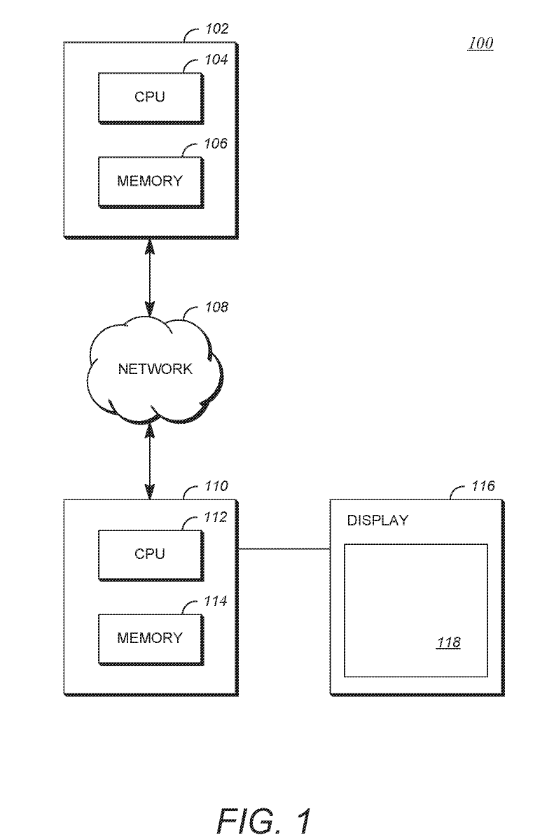

FIG. 1 is a schematic of a video encoding and decoding system 100 in which aspects of the disclosure can be implemented. An example transmitting station 102 can be, for example, a computer having an internal configuration of hardware including a processor such as a central processing unit (CPU) 104 and a memory 106. The CPU 104 is a controller for controlling the operations of the transmitting station 102. The CPU 104 can be connected to the memory 106 by, for example, a memory bus. The memory 106 can be read only memory (ROM), random access memory (RAM) or any other suitable memory device. The memory 106 can store data and program instructions that are used by the CPU 104. Other suitable implementations of the transmitting station 102 are possible. For example, the processing of the transmitting station 102 can be distributed among multiple devices.

A network 108 connects the transmitting station 102 and a receiving station 110 for encoding and decoding of the video stream. Specifically, the video stream can be encoded in the transmitting station 102 and the encoded video stream can be decoded in the receiving station 110. The network 108 can be, for example, the Internet. The network 108 can also be a local area network (LAN), wide area network (WAN), virtual private network (VPN), a cellular telephone network or any other means of transferring the video stream from the transmitting station 102 to, in this example, the receiving station 110.

The receiving station 110 can, in one example, be a computer having an internal configuration of hardware including a processor such as a CPU 112 and a memory 114. The CPU 112 is a controller for controlling the operations of the receiving station 110. The CPU 112 can be connected to the memory 114 by, for example, a memory bus. The memory 114 can be ROM, RAM or any other suitable memory device. The memory 114 can store data and program instructions that are used by the CPU 112. Other suitable implementations of the receiving station 110 are possible. For example, the processing of the receiving station 110 can be distributed among multiple devices.

A display 116 configured to display a video stream can be connected to the receiving station 110. The display 116 can be implemented in various ways, including by a liquid crystal display (LCD), a cathode-ray tube (CRT), or a light emitting diode display (LED), such as an OLED display. The display 116 is coupled to the CPU 112 and can be configured to display a rendering 118 of the video stream decoded in the receiving station 110.

Other implementations of the encoding and decoding system 100 are also possible. For example, one implementation can omit the network 108 and/or the display 116. In another implementation, a video stream can be encoded and then stored for transmission at a later time by the receiving station 110 or any other device having memory. In one implementation, the receiving station 110 receives (e.g., via the network 108, a computer bus, or some communication pathway) the encoded video stream and stores the video stream for later decoding. In another implementation, additional components can be added to the encoding and decoding system 100. For example, a display or a video camera can be attached to the transmitting station 102 to capture the video stream to be encoded.

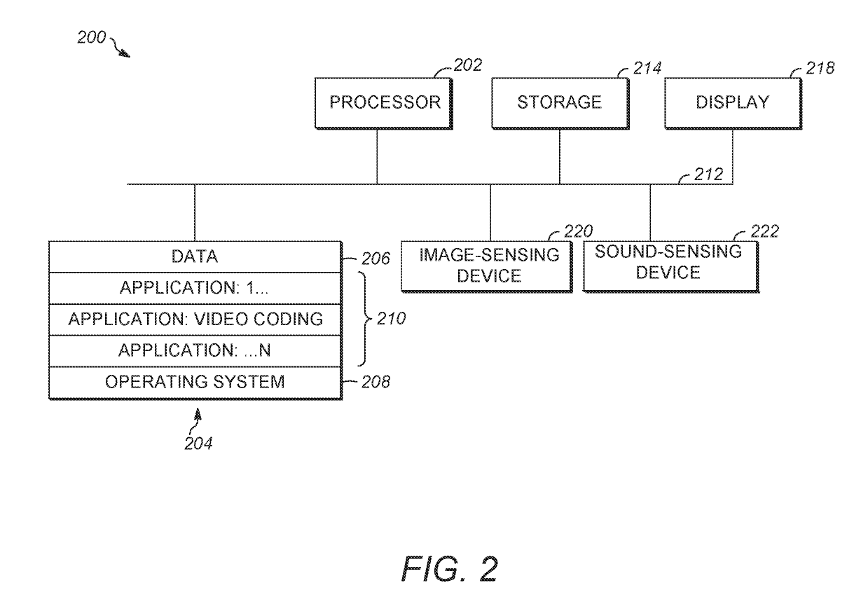

FIG. 2 is a block diagram of an example of a computing device 200 that can implement a transmitting station or a receiving station. For example, the computing device 200 can implement one or both of the transmitting station 102 and the receiving station 110 of FIG. 1. The computing device 200 can be in the form of a computing system including multiple computing devices, or in the form of a single computing device, for example, a mobile phone, a tablet computer, a laptop computer, a notebook computer, a desktop computer, and the like.

A processor 202 in the computing device 200 can be a central processing unit. Alternatively, the processor 202 can be any other type of device, or multiple devices, capable of manipulating or processing information now-existing or hereafter developed. Although the disclosed implementations can be practiced with a single processor as shown, e.g., the processor 202, advantages in speed and efficiency can be achieved using more than one processor.

A memory 204 in the computing device 200 can be a read only memory (ROM) device or a random access memory (RAM) device in an implementation. Any other suitable type of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the methods described here. For example, the application programs 210 can include applications 1 through N, which further include a video coding application that performs the methods described here. The computing device 200 can also include a secondary storage 214, which can, for example, be a memory card used with the computing device 200. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an OLED display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into a single unit, other configurations can be utilized. The operations of the processor 202 can be distributed across multiple machines (each machine having one or more of processors) that can be coupled directly or across a local area or other network. The memory 204 can be distributed across multiple machines such as a network-based memory or memory in multiple machines performing the operations of the computing device 200. Although depicted here as a single bus, the bus 212 of the computing device 200 can be composed of multiple buses. Further, the secondary storage 214 can be directly coupled to the other components of the computing device 200 or can be accessed via a network and can comprise a single integrated unit such as a memory card or multiple units such as multiple memory cards. The computing device 200 can thus be implemented in a wide variety of configurations.

According to implementations of this disclosure, in voxel video coding, a video bitstream is considered to be a voxel image, which is separated into three-dimensional blocks. A three-dimensional block, according to implementations of this disclosure, has a temporal dimension. Unless otherwise noted, the term “block”, also referred to as a voxel block, can include a three-dimensional macroblock, a subblock (i.e., a subdivision of a macroblock), a segment, a slice, a residual block or any other three-dimensional portion of a video stream. The block can also include a multi-dimensional macroblock with more than three dimensions.

A block, according to implementations of this disclosure, has six faces. A face, which is a two-dimensional image, has four edges. An edge, which is a one-dimensional image, has two points (e.g., vertices). A point, a zero-dimensional image, comprises a pixel. The six faces, twelve edges, and eight points are referred to as “corner pixels”, or collectively, a “corner voxel”. The corner pixels can be used to define a boundary of the block. As previously discussed, the term “piece” can refer to a block, or any of the above, such as a face, an edge, or a point that can be used to define the boundary of the block. In some implementations, “boundary pieces” refer to pieces being used to define a boundary of a current piece and having one fewer dimension than the current piece. For example, a block can have six faces as its boundary pieces; a face can have four edges as its boundary pieces; and so on.

A block, a piece, a pixel, or a combination thereof can include display information, such as luminance information, chrominance information, or any other information that can be used to store, modify, communicate, or display the video stream or a portion thereof.

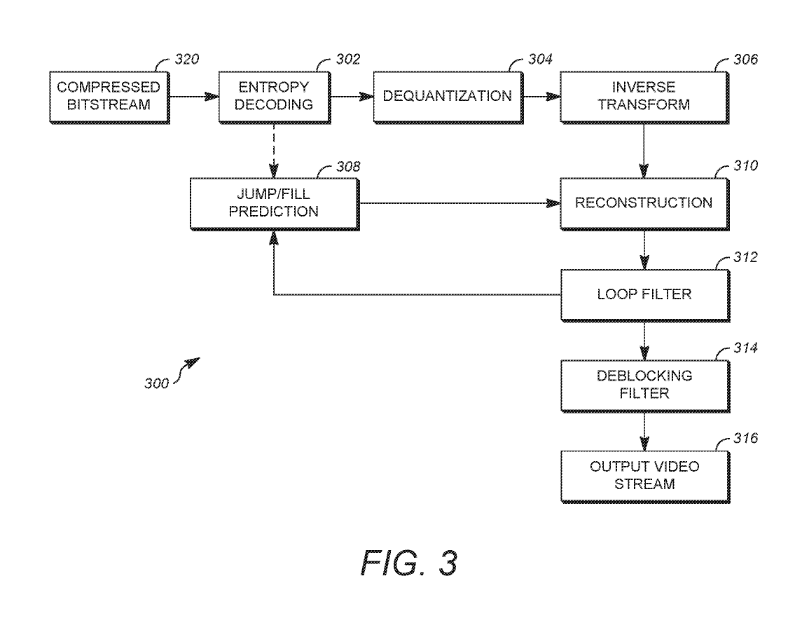

FIG. 3 is a block diagram of a decoder 300 in accordance with implementations of this disclosure. The decoder 300 can be implemented, for example, in the receiving station 110, such as by providing a computer software program stored in memory for example. The computer software program can include machine instructions that, when executed by the CPU 112, cause the receiving station 110 to decode video data in the manner described in FIG. 3. The decoder 300 can also be implemented as specialized hardware or firmware in, for example, the transmitting station 102 or the receiving station 110.

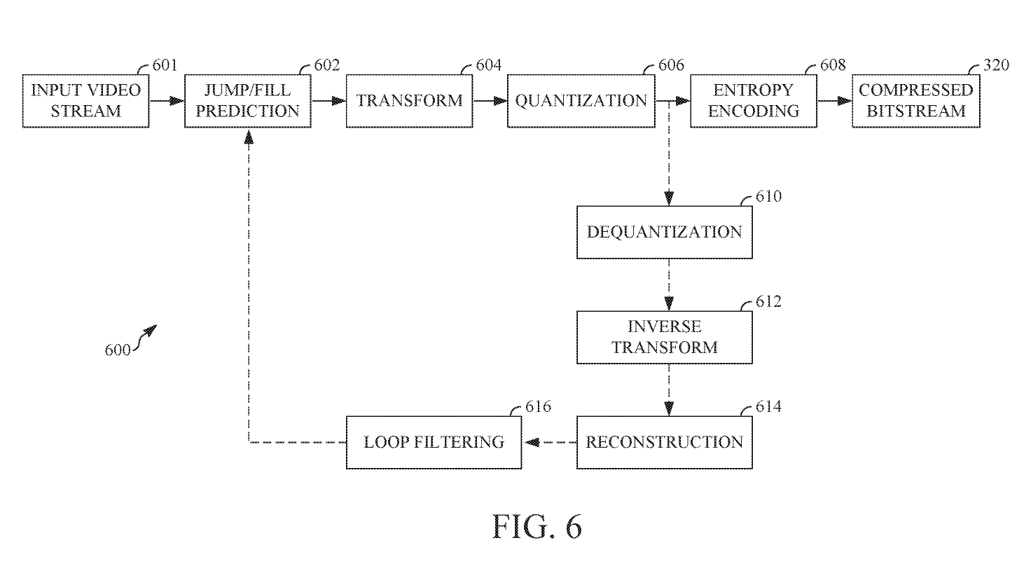

The decoder 300, similar to a reconstruction path of an encoder 600 as shown in FIG. 6, includes in one example the following stages to perform various functions to produce an output video stream 316 from compressed bitstream 320: an entropy decoding stage 302, a dequantization stage 304, an inverse transform stage 306, a jump/fill prediction stage 308, a reconstruction stage 310, a loop filtering stage 312, and a deblocking filtering stage 314. Other structural variations of the decoder 300 can be used to decode the compressed bitstream 320.

When the compressed bitstream 320 is presented for decoding, data within the compressed bitstream 320 can be processed in units of blocks (e.g., macroblocks). When “piece coding” is used, an encoded block can be processed in pieces. As described above, a piece can include the block itself, a face, an edge, or a point defining a boundary of the block or its boundary pieces. The decoding order of the pieces for an encoded block can be specified by the encoder. The decoding order can also be predetermined or inferred from the compressed bitstream 320.

The data elements within the compressed bitstream 320 can be decoded by the entropy decoding stage 302 (using, for example, arithmetic coding) to produce a set of quantized transform coefficients. For a block (or a piece), a set of basis vectors can be used for entropy coding. In some examples, the set of basis vectors for entropy coding can vary in size. For example, an 8×8×8 piece can have as many as 512 basis vectors for entropy coding.

The dequantization stage 304 dequantizes the quantized transform coefficients and the inverse transform stage 306 inverse transforms the dequantized transform coefficients to produce a derivative residual that can be identical to that created by a reconstruction stage in an encoder. The inverse transform stage can be corresponding to a transform stage at the encoder, which transforms the residual into a block (or a piece) of transform coefficients in, for example, the frequency domain. Examples of block-based transforms can include, for example, three-dimensional Fourier-type transforms such as the three-dimensional Discrete Cosine Transform (DCT), Walsh-Hadamard Transform (WHT), the Singular Value Decomposition Transform (SVD) or the Asymmetric Discrete Sine Transform (ADST), etc. Examples of piece-based transforms can include, for example, n-dimensional transforms such as Fourier-type transforms (e.g., n-dimensional DCT transform), where n is the dimension of the piece. In one example, the DCT transforms the block (or the piece) into the frequency domain. In the case of DCT, the transform coefficient values are based on spatial frequency, with the lowest frequency (e.g., DC) coefficient at the top-left of the matrix and the highest frequency coefficient at the bottom-right of the matrix.

Using header information decoded from the compressed bitstream 320, the decoder 300 can use the jump/fill prediction stage 308 to create the same prediction block (or prediction piece) as was created in the encoder, e.g., at a jump/fill prediction stage 602 of the encoder 600. In the case of jump prediction, the reference frame from which the prediction block (or prediction piece) is generated can be transmitted in the bitstream or reconstructed by the decoder using information contained within the bitstream.

As described above, a piece can be predicted using either or both of the two prediction types: jump prediction and fill prediction. Jump prediction can be used to form a prediction piece based on a reference to a previously decoded piece. For jump prediction of a current piece, the decoder can decode, from the bitstream, a reference (such as a pointer or indicator) to a previously decoded piece (“reference piece” or “source piece”). The decoder can then copy the previously decoded piece as a predictor for the current piece (“a first prediction piece”). For example, the information for jump prediction can include the location and orientation of the reference piece.

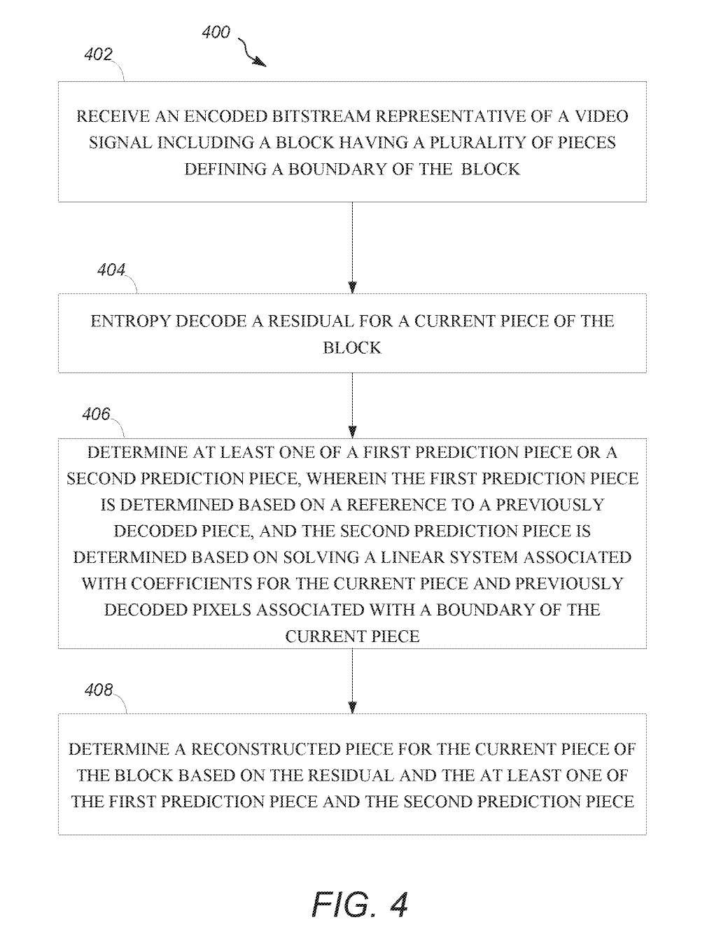

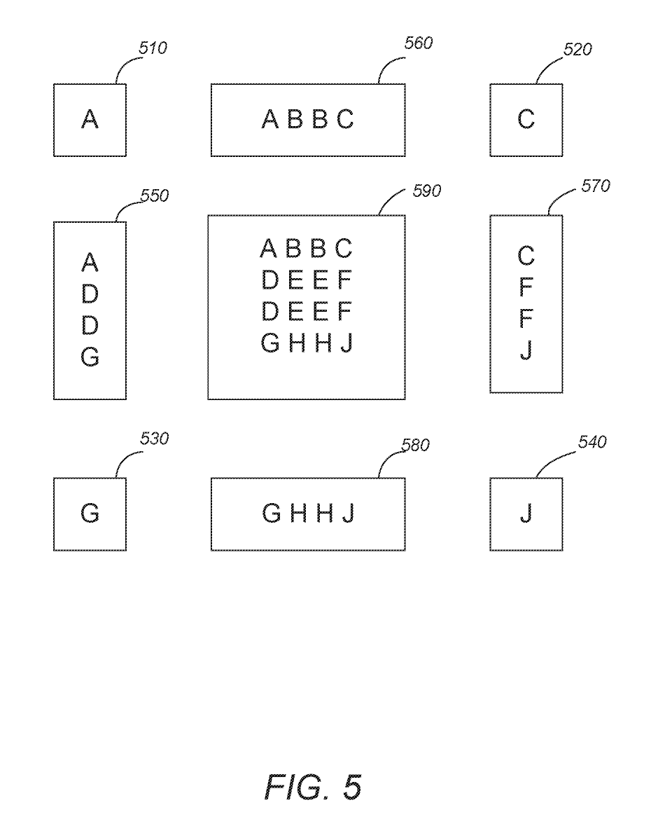

Fill prediction can be used to form a prediction piece based on an affine relationship (e.g., solving a linear system) between coefficients determined for a piece and previously decoded pixels associated with a boundary of the piece. For fill prediction of a current piece, the decoder solves the linear system to generate a predictor for the current piece (“a second prediction piece”). Details of the linear system for the fill prediction are described below in connection with FIGS. 4 and 5.

At the reconstruction stage 310, the prediction block (or prediction piece) can be added to the derivative residual to create a reconstructed block (or reconstructed piece) that can be identical to the block (or piece) created by a reconstruction stage 614 in the encoder (FIG. 6). For example, when both prediction types are used for predicting a piece, a sum of the prediction pieces resulted from using jump prediction and fill prediction can be used as the prediction piece.

In some implementations, the loop filtering stage 312 can be applied to the reconstructed block (or piece) to reduce blocking artifacts. Deblocking filtering stage 314 can be applied to the reconstructed block (or piece) to reduce blocking distortion, and the result is output as output video stream 316. The output video stream 316 can also be referred to as a decoded video stream and the terms will be used interchangeably herein.

Other variations of the decoder 300 can be used to decode the compressed bitstream 320. For example, the decoder 300 can produce the output video stream 316 without the deblocking filtering stage 314.

FIG. 4 is a flow diagram of an example decoding process 400 of a video stream (also referred to as video bitstream) in accordance with implementations of this disclosure. Process 400 can be implemented, for example, in a decoder such as decoder 300 (shown in FIG. 3) or an encoder such as encoder 600 (shown in FIG. 6). Process 400 can be implemented, for example, as a software program that can be executed by computing devices such as transmitting station 102 or receiving station 110 (shown in FIG. 1). For example, the software program can include machine-readable instructions that may be stored in a memory such as memory 106 or 114, and that, when executed by a processor, such as CPU 104 or 112, may cause the computing device to perform process 400. Process 400 can be implemented using specialized hardware or firmware. As explained above, some computing devices may have multiple memories or processors, and the steps of process 400 can be distributed using multiple processors, memories, or both.

For simplicity of explanation, process 400 is depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

At a step 402, process 400 receives an encoded bitstream representative of video data (e.g., a video signal) including a block. The block includes pieces defining a boundary of the block. The block includes a temporal dimension. This information about the block and the pieces can be communicated by reading and decoding bits from the encoded bitstream according to one of the techniques disclosed above. The pieces include a current piece. The encoded bitstream may have been received by the decoder in any number of ways, such as by receiving the video data over a network, over a cable, or by reading the video data from a primary memory or other storage device, including a disk drive or removable media such as a DVD, CompactFlash (CF) card, Secure Digital (SD) card, or any other device capable of communicating a video stream. Step 402 involves decoding at least a portion of the encoded bitstream to extract the information regarding the block and the pieces defining the boundary of the block. This information can be included in a header associated with the encoded bitstream or a portion of the encoded bitstream (e.g., a block), for example. In one example, the information in the one or more headers can indicate to the decoder that the current piece is to be decoded using jump prediction.

At a step 404, process 400 decodes, from the encoded bitstream, a residual for the current piece of the block using entropy decoding. The data elements within the encoded bitstream can be decoded by entropy decoding using, for example, arithmetic coding, to produce a set of quantized transform coefficients, which can be inverse transformed (e.g., using a n-dimensional Fourier-type transform where n is the dimension of the current piece) to produce the residual.

At a step 406, process 400 determines at least one of a first prediction piece or a second prediction piece for the current piece of the block using a processor, where the first prediction piece is determined based on a reference to a previously decoded piece (“jump prediction”), and the second prediction piece is determined based on solving a linear system associated with coefficients for the current piece and previously decoded pixels associated with a boundary of the current piece (“fill prediction”). For example, the prediction piece for the current piece of the block can be determined as the first prediction piece (jump prediction only), the second prediction piece (fill prediction only), or a combination of the first prediction piece and the second prediction piece (jump and fill prediction).

When jump prediction is used for predicting the current piece, the decoder can decode, from the encoded bitstream, a reference (such as a pointer or indicator) to a previously decoded piece (“reference piece” or “source piece”) and use the previously decoded piece as a predictor for the current piece (the “first prediction piece”). For example, the information for jump prediction can include the location and orientation of the reference piece.

When fill prediction is used for predicting the current piece, the decoder solves a linear system (e.g., one where there is an affine relationship between the reference piece and the prediction piece) to generate a predictor for the current piece (the “second prediction piece”).

In one implementation, the linear system can be solved by equation Ax=By+C where the following conditions apply: (1) A is a n-by-n diagonally dominant matrix; (2) B is an n-by-m matrix; (3) C is a vector with n components; (4) x is an unknown vector to be solved with n components; and (5) y is a vector with m components. Here n is the number of interior pixels of a piece, and m is the number of pixels on the boundary (“boundary pixels”). Matrices A, B and vector C can be encoded. From the decoder side, A, B, C can be decoded from the encoded bitstream, as will be described further in the examples below.

For example, the following is a 4×4 two-dimensional piece:
0 1 2 3
4 5 6 7
8 9 a b
c d e f

In this example, the interior pixels of the piece include four pixels, namely “5, 6, 9, a.” The other twelve pixels of the piece are the boundary pixels. In this example, m=4 and n=12. For the linear system as indicated by equation Ax=By+C, y will be pixel values of the boundary pixels for the piece, and x will be fill-predicted pixel values. In this implementation, fill prediction of a piece is done after all its boundary pieces have values.

In the cases where the pixels on a boundary of a current piece to be predicted are available, the interior of the current piece can be filled by numerical iterations that can be used to solve the linear equation Ax=By+C. The vector x that satisfies Ax=By+C on the interior pixels can be solved by various numerical methods such as Jacobi, Gauss-Seidel, or conjugate gradient (such as when the matrix A is symmetric). An encoder can be designed to find A, B and C that yield x that is as close as the actual image as possible. For example, numerical optimization can be used to optimize A, B and C. The basis matrices and vectors can be selected from Fourier-type basis matrix and vectors.

As an example, fill prediction is performed for a one-dimensional piece that has eight pixels (including two boundary points), where m=2 and n=6. A and B can be created from, for example, the second order central difference scheme and C can be, for example, a linearly increasing source term as follows:

$$A = [ \begin{matrix}2 & - 1 & 0 & 0 & 0 & 0 \\ - 1 & 2 & - 1 & 0 & 0 & 0 \\ 0 & - 1 & 2 & - 1 & 0 & 0 \\ 0 & 0 & - 1 & 2 & - 1 & 0 \\ 0 & 0 & 0 & - 1 & 2 & - 1 \\ 0 & 0 & 0 & 0 & - 1 & 2\end{matrix} ] , \\ x = [ \begin{matrix}{x}_{1} \\ {x}_{2} \\ {x}_{3} \\ {x}_{4} \\ {x}_{5} \\ {x}_{6}\end{matrix} ] , B = [ \begin{matrix}1 & 0 \\ 0 & 0 \\ 0 & 0 \\ 0 & 0 \\ 0 & 0 \\ 0 & 1\end{matrix} ] , y = [ \begin{matrix}{x}_{0} \\ {x}_{7}\end{matrix} ] , C = [ \begin{matrix}1 \\ 2 \\ 3 \\ 4 \\ 5 \\ 6\end{matrix} ] \\ [ \begin{matrix}2 & - 1 & 0 & 0 & 0 & 0 \\ - 1 & 2 & - 1 & 0 & 0 & 0 \\ 0 & - 1 & 2 & - 1 & 0 & 0 \\ 0 & 0 & - 1 & 2 & - 1 & 0 \\ 0 & 0 & 0 & - 1 & 2 & - 1 \\ 0 & 0 & 0 & 0 & - 1 & 2\end{matrix} ] \times [ \begin{matrix}{x}_{1} \\ {x}_{2} \\ {x}_{3} \\ {x}_{4} \\ {x}_{5} \\ {x}_{6}\end{matrix} ] = [ \begin{matrix}1 & 0 \\ 0 & 0 \\ 0 & 0 \\ 0 & 0 \\ 0 & 0 \\ 0 & 1\end{matrix} ] \times [ \begin{matrix}{x}_{0} \\ {x}_{7}\end{matrix} ] + [ \begin{matrix}1 \\ 2 \\ 3 \\ 4 \\ 5 \\ 6\end{matrix} ] \qquad [ Equation one ]$$

Here x₀ and x₇ are the boundary values that are assumed to be known at the time of fill prediction. For example, Gauss-Seidel method can be used to solve

$$[ \begin{matrix}{x}_{1} \\ {x}_{2} \\ {x}_{3} \\ {x}_{4} \\ {x}_{5} \\ {x}_{6}\end{matrix} ] .$$

Each iteration can be as follows:

$${x}_{1}^{i + 1} = \frac{1}{2} ( {x}_{0} + {x}_{2}^{i} + 1 ) \\ {x}_{2}^{i + 1} = \frac{1}{2} ( {x}_{1}^{i + 1} + {x}_{3}^{i} + 2 ) \\ {x}_{3}^{i + 1} = \frac{1}{2} ( {x}_{2}^{i + 1} + {x}_{4}^{i} + 3 ) \\ {x}_{4}^{i + 1} = \frac{1}{2} ( {x}_{3}^{i + 1} + {x}_{5}^{i} + 4 ) \\ {x}_{5}^{i + 1} = \frac{1}{2} ( {x}_{4}^{i + 1} + {x}_{6}^{i} + 5 ) \\ {x}_{6}^{i + 1} = \frac{1}{2} ( {x}_{5}^{i + 1} + {x}_{7}^{i} + 6 ) \qquad [ Equation Two ]$$

For example, if x₀=0 and x₇=98,

$$[ \begin{matrix}{x}_{1} \\ {x}_{2} \\ {x}_{3} \\ {x}_{4} \\ {x}_{5} \\ {x}_{6}\end{matrix} ] = [ \begin{matrix}22 \\ 43 \\ 62 \\ 78 \\ 90 \\ 97\end{matrix} ]$$

according to Equation Two. Here the superscript indicates the number of iteration and the subscript indicates the component of the vector, which indicates the pixel location.

In another example, a different linear system with a different matrix A can be used for fill prediction of the one-dimensional piece. This results in “smearing” the two boundary values to the middle of the piece, with some “noise” from C. This linear system can be solved by, for example, Jacobi or Gauss-Seidel method, either of which will terminate within three iterations regardless of the initial guess. For example, the equation for solving this linear system is as follows:

$$\underbrace{[ \begin{matrix}1 & 0 & 0 & 0 & 0 & 0 \\ - 1 & 1 & 0 & 0 & 0 & 0 \\ 0 & - 1 & 1 & 0 & 0 & 0 \\ 0 & 0 & 1 & - 1 & 0 & 0 \\ 0 & 0 & 0 & 0 & 1 & - 1 \\ 0 & 0 & 0 & 0 & 0 & 1\end{matrix} ]}_{A} \times \underbrace{[ \begin{matrix}{x}_{1} \\ {x}_{2} \\ {x}_{3} \\ {x}_{4} \\ {x}_{5} \\ {x}_{6}\end{matrix} ]}_{x} \times \underbrace{[ \begin{matrix}1 & 0 \\ 0 & 0 \\ 0 & 0 \\ 0 & 0 \\ 0 & 0 \\ 0 & 1\end{matrix} ]}_{B} \times \underbrace{[ \begin{matrix}{x}_{0} \\ {x}_{7}\end{matrix} ]}_{y} + \underbrace{[ \begin{matrix}1 \\ 2 \\ 3 \\ 4 \\ 5 \\ 6\end{matrix} ]}_{C} \qquad [ Equation Three ]$$

The iteration for solving the linear system is as follows:

xᵢ=xᵢ₋₁+i, i=1, 2, 3

xᵢ=xᵢ₊₁+i, i=4, 5, 6 [Equation Four]

To achieve high compression ratio, A can be constrained to be selected from a certain fixed set of basis matrices, which is a subset of all diagonally dominant matrices.

In addition, “iteration hint” can be coded at the choice of the encoder to give the decoder (e.g., the decoder 300) a suggestion of an initial solution for an iteration that yields faster convergence. Details of iteration hint are described further below.

At a step 408, process 400 determines a reconstructed piece for the current piece of the block based on the residual and the at least one of the first prediction piece and the second prediction piece

Once the current piece is decoded and reconstructed, the next piece is processed. When all of the pieces of a block are decoded and reconstructed, the next block is processed. The output can be an output video stream, such as the output video stream 316 shown in FIG. 3.

In some implementations, “iteration hint” can be used to speed up the decoding process for fill prediction. The iteration hint can be coded at the choice of the encoder to give the decoder (e.g., the decoder 300) a suggestion of an initial solution for an iteration of solving the linear system (such as Ax=By+C) for the fill prediction that yields faster convergence. For example, an encoder can choose to code a parameter for the SOR (successive over-relaxation) or weighted Jacobi method that yields faster convergence than the basic version of Gauss-Seidel or Jacobi iteration. Also, the iteration hint can include more information, such as an initial guess and/or the number of iterations. For example, the encoder can choose to suggest an initial solution for the iterations and the number of iterations. The encoder can also specify the method to solve the linear equations, as well as other parameters related to the method. It is also possible for the encoder to inform the decoder to terminate the iteration before the actual solution is found. In one example, the encoder may specify the following as iteration hint: “use successive overrelaxation with red-black ordering, starting with 0.5b as the initial solution, and iterate 7 times using relaxation factor 1.25.”

Due to the nature of the temporal dimension, it can be expected that blocks will have varying depths. It is the responsibility of the encoder to find a good way to split the voxel image and order corresponding pieces in a way that is easily decodable. If certain key frames are given in advance, they should be taken into consideration too.

In some implementations, basis matrices A, B and vector C can be preselected by the encoder and communicate to the decoder in the encoded bitstream. This is because a piece can be one-, two- or three-dimensional, A, B, C can vary in size, and m and n can also vary. The encoder can communicate to the decoder in the bitstream about how Aᵢ, Bᵢ and cᵢ can be chosen, for the current piece or block, or at the bitstream level.

In some implementations, while both jump prediction and fill prediction can be used to predict a piece, certain restrictions or constraints may be applied. For example, one or more of the following constraints may be applied:

First Constraint. For a piece, coding can be processed in the order of jump prediction, fill prediction, and entropy coding. A coding stage can be mandatory to consider, and “non-trivial” when the coding stage is used (therefore “trivial” when it is not used).

These coding stages can be interleaved among pieces in the same block. For example, in some implementations, the following piece coding order can be used: jump prediction for a block, jump prediction for a two-dimensional piece (face), jump prediction for a one-dimensional piece (edge), jump prediction for corner pixels, fill prediction for corner pixels, entropy coding for corner pixels, fill prediction for one-dimensional piece (edge), entropy coding of one-dimensional piece (edge), fill prediction for a two-dimensional piece (face), fill prediction for the block (the three-dimensional piece), entropy coding for the block (the three-dimensional piece). Ordering of pieces in the same dimension can also be predetermined. For example, coding for the corner pixels can start from a corner pixel at the lower-left corner and proceed in a predetermined direction.

Second constraint. Fill prediction of a piece can only be done after all its boundary pieces have been non-trivially coded, e.g., non-trivially jump-predicted, non-trivially fill-predicted, or fully coded (e.g., predicted and entropy coded). The linear system for the fill prediction can be constructed based on the available information of the boundary pieces, and some of the boundary piece may not have been fully coded. This allows the possibility of filling just the background (e.g., low frequency features) even in the presence of high deviation on the boundary.

Third constraint. If piece X is a boundary piece of piece Y, and the jump prediction of X is not trivial, then the jump prediction of X must come before the jump prediction of Y, and the jump prediction of Y will have a reduced domain which does not include X. This is referred to as the instance where the jump prediction of X “shadows” the jump prediction of Y.

Fourth constraint. If piece X and piece Y share a boundary piece Z, and a non-trivial jump prediction of X happens before the jump predictions of Y and Z, then the jump prediction of Y (if non-trivial) will have a reduced domain which does not include Z. This is referred to as the instance where the jump prediction of Z “shadows” the jump prediction of Y. In some implementations, the jump prediction of a piece can be “shadowed” by multiple pieces.

Fifth constraint. The constraints applicable to jump prediction (constraints 3 and 4) are also applicable for entropy coding. It is also possible for the shadowing for the jump prediction and the shadowing for entropy coding to be different, such as by different pieces.

FIG. 5 shows an example piece subject to certain coding constraints. As shown in FIG. 5, a piece 590, a two dimensional 4×4 piece, has four edge pieces (pieces 550, 560, 570, 580) and four corners pieces (pieces 510, 520, 530, 540). The total number of pieces to be coded for the 4×4 piece is nine. The nine pieces are as follows:

### Piece 510:

### A

### Piece 520:

### C

### Piece 530:

### G

### Piece 540:

### J

### Piece 550:

### A

### D

### D

### G

### Piece 560:

### ABBC

### Piece 570:

### C

### F

### F

### J

### Piece 580:

### GHHJ

### Piece 590:

### ABBC

### DEEF

### DEEF

### GHHJ

If the jump prediction of piece 590 comes before any other pieces are jump-predicated, then it would be a copy of a 4×4 patch from somewhere else.

If piece 550 is jump predicted before piece 590 is (and no other pieces are jump predicted before piece 590), the jump prediction of piece 590 can be on the 3×4 patch:

### BBC

### EEF

### EEF

### HHJ

If piece 550 is jump predicted before piece 560 is (and pieces 510, 520, and 570 are not jump predicted before piece 560), the jump prediction of 6 can be on the 3×1 strip:

### BBC

In the implementations where the corner pixels are specially treated, pieces 510, 520, 530 and 540 (including the other four corner pixels that are not shown for a block) can be predicted together, as will be described below.

The fill prediction of piece 590 can be used to fill the 2×2 patch inside the piece 590:

### EE

### EE

Entropy coding of the pieces can also be processed similarly. For example, if entropy coding of piece 590 is done first, then it is done on the whole piece.

If piece 580 is entropy encoded before piece 590 (and no other pieces are entropy coded before piece 590), then the entropy coding of piece 590 can operate on the 4×3 patch:

### ABBC

### DEEF

### DEEF

In some implementations, some or all corner pixels, which are 0-dimensional pieces, can be coded differently. A pixel can be represented as a triple, such as RGB, YCbCr, or any other representations, using a relatively small amount of data. The corner pixels for a block can be grouped together into a 2×2×2 block, which can be referred to as a “corner voxel”. For example, the corner voxel can include 8 corner pixels. To support jump prediction, coded corner voxel can be stored in a list, referred to as a “corner voxel list,” in the order that the corner pixels are coded for the corner voxel. For example, the order for coding the corner voxels can be the same as the order in which the corresponding blocks are coded.

A corner voxel can be coded using the following modified operations. Similar to other pieces, it is possible that not all operations are used for each corner pixel (e.g., any of the operations can be “trivial”).

Jump prediction for a corner pixel can be processed by storing a reference to (e.g., the relative index of) a source corner pixel in the corner voxel list.

Fill prediction can be processed by coding the mean of the corner pixels.

Entropy coding can use the same entropy coding methods used by other pieces.

To apply some of the coding constraints described above to the special cases of the corner voxel, the corner voxel can be viewed as a special piece of dimension between 0 and 1, and the corner voxel can “shadow” or “be shadowed” by pieces of higher dimensions during jump prediction and entropy coding.

For example, consider the 4×4 piece in the example of FIG. 5, which includes four corner pixels (“A”, “C”, “G”, “J”) of the corner voxel as follows:

### ABBC

### DEEF

### DEEF

### GHHJ

If piece ABBC, i.e., piece 560 in FIG. 5, has been jump predicted before the corner voxel, then pixels A and C can be removed from the jump prediction of the corner voxel. If the corner voxel has been jump predicted before piece ABBC, then the jump prediction of piece ABBC may just consider a 2-pixel patch BB.

For jump prediction, the corner voxel cannot be predicted from the decoded portion of the video. Additionally, for jump prediction, the corner voxel can be predicted from the corner voxel list. The fill prediction of a corner voxel can be determined as an average of the eight corner pixels. This can save space when the corner pixels are similar. In some implementations, the encoder encodes the mean of the input pixels, and the decoder uses the mean value (added to respective residual values) for each of the corner pixels. In some implementations, some of the corner pixels can be predicted from one or more of previously decoded corner pixels.

In some implementations, key frames can be used to facilitate seeking. For example, random seeking in a video can be facilitated by inserting the key frames into the video bitstream. For example, the key frames can include an I-frame or an intra-coded frame in a video codec (such as the standard ones currently existing or developed in the future). Since blocks may have different depths in the voxel codec, seeking can be difficult because a frame at a given depth can intersect blocks that start at different depths (times). To create a key frame, it can be required that each piece that intersects the key frame does not have jump prediction from a piece that does not intersect the key frame. This way the encoder can produce the key frame in a more straightforward manner. This requirement can also be used to help facilitate generation of key frames. For example, key frames can be generated by the decoder according to this requirement, even in cases where the encoder did not obey this requirement. In some implementations, a piece that intersects the key frame can be required to have a small depth. In some implementations, all blocks have a limit on its depth.

In some implementations, locations of blocks can be coded relatively, and it can be beneficial to code nearby blocks together. The width and height can be predefined or restricted to a certain size. Because a scene change can happen at an arbitrary location in a video sequence, which will very likely “end” a block, it is possible for the depth of the block to have no lower bound.

In some implementations, the decoder can specify the number of blocks that will need to be kept (and maybe the amount of memory needed to keep them) for referencing.

In some implementations, let the boundary values be a column vector X, then Bᵢ=MᵢX, where Mᵢ can be a non-square matrix. When determining Aᵢ's, Mᵢ's can also be determined.

FIG. 6 is a block diagram of an encoder 600 in accordance with implementations of this disclosure. The encoder 600 can be implemented, as described above, in the transmitting station 102 such as by providing a computer software program stored in memory, for example, the memory 204. The computer software program can include machine instructions that, when executed by a processor such as the CPU 104, cause the transmitting station 102 to encode video data in the manner described in FIG. 6. The encoder 600 can also be implemented as specialized hardware included in, for example, the transmitting station 102. For example, the encoder 600 can be a hardware encoder.

The encoder 600 has the following stages to perform the various functions in a forward path (shown by the solid connection lines) to produce an encoded or compressed bitstream 620 using a video stream 601 as input: a jump/fill prediction stage 602, a transform stage 604, a quantization stage 606, and an entropy encoding stage 608. The encoder 600 may also include a reconstruction path (shown by the dotted connection lines) to reconstruct a frame for encoding of future blocks. In FIG. 6, the encoder 600 has the following stages to perform the various functions in the reconstruction path: a dequantization stage 610, an inverse transform stage 612, a reconstruction stage 614, and a loop filtering stage 616. Other structural variations of the encoder 600 can be used to encode the video stream 601.

When presented for encoding, the video stream 601 can be processed in units of blocks. At the jump/fill prediction stage 602, a block (or a piece) can be encoded using jump prediction or fill prediction, or a combination of both. In any case, a prediction block (or a prediction piece) can be formed. As discussed above in connection with FIGS. 3-5, in the case of jump prediction, a prediction piece is formed based on a reference to a previously encoded piece. The previously encoded piece can be decoded and reconstructed using the reconstruction path in FIG. 6. For example, the information for jump prediction can include the location and orientation of the reference piece. In the case of fill prediction, a prediction piece can be formed based on solving a linear system between coefficients for a piece and previously encoded pixels associated with a boundary of the piece. Details of the linear system for the fill prediction are described in connection with FIGS. 4 and 5 and elsewhere. Implementations for voxel video coding are discussed above with respect to FIGS. 3-5.

At the jump/fill prediction stage 602, similar to step 406 of the example decoding process 400, a first prediction piece or a second prediction piece can be determined for a current piece of a block of the video data. As described above, the block has a plurality of pieces defining a boundary of the block, and the plurality of pieces includes the current piece. The first prediction piece is determined based on a reference to a previously encoded piece of the video data. The second prediction piece is determined based on solving a linear system associated with coefficients for the current piece and previously encoded pixels associated with a boundary of the current piece.

The current piece can be predicted using either or both of jump prediction and fill prediction. When both prediction types are used for the piece, a sum of the prediction pieces resulted from using jump prediction and fill prediction can be used as the prediction piece. The prediction piece is then subtracted from the piece to from a residual, which can be transformed and entropy coded.

The coefficients for the current piece, such as coefficients for matrices A, B and vector C can be encoded into the video bitstream. Basis matrices such as Aᵢ, Bᵢ and cᵢ can be preselected, for example, based on the size of the current piece. Thus, it is not necessary to encode basis matrices and basis vectors. In some implementations, the encoder can communicate to the decoder in the bitstream about how Aᵢ, Bᵢ and cᵢ can be chosen, for the current piece or block, or at the bitstream level.

In the implementation where the linear system is solved by equation Ax=By+C, matrix A can be a convex combination of pre-selected diagonally dominant matrices A₁, . . . , Aₖ. A=a₁A₁+a₂A₂+ . . . +aₖAₖ, where 0≤aᵢ≤1 and a₁+ . . . +aₖ=1. To reduce coding cost, one of the aᵢ does not need to be coded because a₁+ . . . +aₖ=1. For example, coefficients a₁, . . . , aₖ₋₁ can be coded.

In this implementation, the same aᵢ can be used to construct matrix B from B=a₁B₁+a₂B₂+ . . . aₖBₖ, where B₁, . . . , Bₖ are pre-selected matrices. Vector C can be formed as a linear combination of pre-selected vectors C₁, . . . , Cₗ as follows: C=c₁C₁+c₂C₂+ . . . +c₁Cₗ. For example, coefficients c₁, . . . , cₗ can be coded.

The choices of pre-selected matrices such as A₁, . . . , Aₖ, B₁, . . . , Bₖ, and pre-selected vectors such as C₁, . . . , Cₗ depend on the size of the current piece. For example, the size of a three-dimensional piece can be defined as the width of the piece multiplies the height of the piece multiplies the depth of the piece (“width×height×depth”). For each piece size, the pre-selected matrices and vectors do not need to be coded. For example, construction methods can be communicated in the bitstream such that the decoder can use the same matrices and vectors. For example, multiple different construction methods can be used for coding a piece of a certain size, and the encoder can make a selection and communicate the selected construction method in the bitstream, which can be used by the decoder to reconstruct the matrices and vectors.

Since A and B are formed using the same coefficients a₁, . . . , aₖ, matrices A₁, . . . , Aₖ and B₁, . . . , Bₖ can be chosen together. For example, Aᵢ can be chosen to represent a discrete differential operator, and Bᵢ can be chosen to correspond to discretized boundary conditions with respective to Aᵢ. For example, when Aᵢ is chosen as the discrete Laplacian operation, the solution to A₁x=B₁y+C would be a solution to a discretized steady-state heat equation.

Vectors such as C₁, . . . , Cₗ can be arbitrarily chosen. For fill prediction, most of the changes within a macroblock are small. Therefore, in some implementations, Cᵢ can be chosen as low-frequency sin and cos functions, or low-order discrete Chebyshev polynomials.

With respect to solving the linear system, the encoder can indicate how equation(s) for the linear system should be solved by the decoder. The communication can be performed at different levels of the video coding process, such as at the bitstream level, at a group of macroblocks level, or at the macroblock level. The encoded iteration information can include the method to solve the linear system and parameters relating to the method. For example, the encoder can indicate to the decoder to use a method of successive over relaxation with red-black ordering, and the parameters can include starting with 0.5 C as the initial condition, and iterate seven times using relaxation factor 1.25. Techniques that can be used to solve the linear system are not limited to numerical methods, and can also include other methods such as Gaussian elimination. For example, diagonal dominance can obviate partial pivoting, and Gaussian elimination will preserve the band structure.

Next, still referring to FIG. 6, the prediction block (or prediction piece) can be subtracted from the current block (or current piece) at the jump/fill prediction stage 602 to produce a residual block (or residual piece, also called a residual). The transform stage 604 transforms the residual into transform coefficients in, for example, the frequency domain using block-based transforms. Such block-based transforms include, for example, the Discrete Cosine Transform (DCT) and the Asymmetric Discrete Sine Transform (ADST). Other block-based transforms are possible. Further, combinations of different transforms may be applied to a single residual. In one example of application of a transform, the DCT transforms the residual block into the frequency domain where the transform coefficient values are based on spatial frequency. The lowest frequency (DC) coefficient at the top-left of the matrix and the highest frequency coefficient at the bottom-right of the matrix. It is worth noting that the size of a prediction block, and hence the resulting residual block, may be different from the size of the transform block. For example, the prediction block may be split into smaller blocks to which separate transforms are applied.

The quantization stage 606 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 608. Entropy coding may be performed using any number of techniques, including token and binary trees. The entropy-encoded coefficients, together with other information used to decode the block, which may include for example the type of prediction used, transform type, motion vectors and quantizer value, are then output to the compressed bitstream 320. The information to decode the block may be entropy coded into block, frame, slice and/or section headers within the compressed bitstream 320. The compressed bitstream 620 can be formatted using various techniques, such as variable length coding (VLC) or arithmetic coding. The compressed bitstream 320 can also be referred to as an encoded video stream or encoded video bitstream, and the terms will be used interchangeably herein.

The reconstruction path in FIG. 6 (shown by the dotted connection lines) can be used to ensure that both the encoder 600 and a decoder 300 (described above) use the same reference frames and blocks to decode the compressed bitstream 320. The reconstruction path performs functions that are similar to functions that take place during the decoding process that are discussed in more detail below, including dequantizing the quantized transform coefficients at the dequantization stage 610 and inverse transforming the dequantized transform coefficients at the inverse transform stage 612 to produce a derivative residual block (also called a derivative residual). At the reconstruction stage 614, the prediction block that was predicted at the jump/fill prediction stage 602 can be added to the derivative residual to create a reconstructed block. The loop filtering stage 616 can be applied to the reconstructed block to reduce distortion such as blocking artifacts.

Other variations of the encoder 600 can be used to encode the compressed bitstream 320. For example, a non-transform based encoder 600 can quantize the residual signal directly without the transform stage 604 for certain blocks or frames. In another implementation, an encoder 600 can have the quantization stage 606 and the dequantization stage 610 combined into a single stage.

Linear systems other than the linear system described above can also be used. For example, in another implementation, the linear system can be solved by equation Ax=b+B where coefficients for A and b are decoded from the encoded bitstream. Here A is a diagonally dominant square matrix where A=c₁A₁+c₂A₂+ . . . +cₘAₘ, and b is a vector where b=d₁b₁+d₂b₂+ . . . +dₙbₙ. Here B=c₁B₁+c₂B₂+ . . . +cₙBₙ. Aᵢ can be a basis matrix, which can be pre-selected, while the coefficients c₁, . . . , cₙ can be coded. The vector b can also be coded by picking certain basis vectors b₁, . . . , bₙ and coding the coefficients d₁, . . . , dₙ. In some implementations, the encoder may set b to be zero. Here B can be based on coefficients determined for the current piece (e.g., c₁, . . . , cₙ) and previously decoded (therefore “available”) pixels associated with a boundary of the current piece. For example, B can be a matrix constructed from boundary pieces (in a way compatible with the choice of A) of the current piece. In some implementations, B does not need to be coded, and can be derived from the available (e.g., already decoded and reconstructed) boundary pieces and coefficients cᵢ's (coefficients in front of Aᵢ's in A=c₁A₁+c₂A₂+ . . . +cₘAₘ). When the boundary pixel values are given, B can be formed by B=c₁B₁+c₂B₂+ . . . +cₙBₙ.

In this implementation, the following coefficients can be coded into the bitstream and therefore decoded from the encoded bitstream:

(1) Non-negative coefficients cᵢ's for A that sum to 1. A convex combination A=c₁A₁+c₂A₂+ . . . +cₘAₘ can be formed, where Aᵢ are diagonally dominant matrices that can be preselected. Number m can also be a preselected number. Coefficient cᵢ can be coded losslessly. To reduce coding cost, one of the cᵢ's can be omitted because c₁+ . . . +cₘ=1.

(2) Coefficients dᵢ's for b. A linear combination b=d₁b₁+d₂b₂+ . . . +dₙbₙ can be formed, where bᵢ is a preselected vector. Number n can also be a preselected number.

For example, if Aᵢ's is symmetric, the decoder can be instructed to use the conjugate gradient algorithm to solve for x in Ax=b+B.

In another example, for a 4×4 piece (which is a two-dimensional piece), if m=1, A₁ is an identity matrix, n=16, and bᵢ's are basis vectors for a two-dimensional discrete transform, then the fill prediction stage can be similar to the entropy coding if the encoder codes the optimal dᵢ's.

In some implementations, generally, each color component (e.g., RGB or YCbCr) can be coded separately. In some instances, if the encoder chooses to code all color components together, parameters m and n can be multiplied by the number of components. This can result in a larger system, which will be harder to solve, but solving it may take into consideration more correlations among the color components.

The aspects of encoding and decoding described above illustrate some exemplary encoding and decoding techniques. However, it is to be understood that encoding and decoding, as those terms are used in the claims, could mean compression, decompression, transformation, or any other processing or change of data.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of transmitting station 102 and/or receiving station 110 (and the algorithms, methods, instructions, etc., stored thereon and/or executed thereby, including by an encoder and the decoder 300) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of transmitting station 102 and receiving station 110 do not necessarily have to be implemented in the same manner.

Further, in one aspect, for example, transmitting station 102 or receiving station 110 can be implemented using a general purpose computer or general purpose processor with a computer program that, when executed, carries out any of the respective methods, algorithms and/or instructions described herein. In addition or alternatively, for example, a special purpose computer/processor can be utilized which can contain other hardware for carrying out any of the methods, algorithms, or instructions described herein.

Transmitting station 102 and receiving station 110 can, for example, be implemented on computers in a video conferencing system. Alternatively, transmitting station 102 can be implemented on a server and receiving station 110 can be implemented on a device separate from the server, such as a hand-held communications device. In this instance, transmitting station 102 can encode content using an encoder 600 into an encoded video signal and transmit the encoded video signal to the communications device. In turn, the communications device can then decode the encoded video signal using a decoder 300. Alternatively, the communications device can decode content stored locally on the communications device, for example, content that was not transmitted by transmitting station 102. Other suitable transmitting station 102 and receiving station 110 implementation schemes are available. For example, receiving station 110 can be a generally stationary personal computer rather than a portable communications device and/or a device including an encoder may also include the decoder 300.

Further, all or a portion of implementations of the present disclosure can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for decoding a video bitstream, comprising:
receiving an encoded bitstream being representative of video data, the video data comprising a block having a plurality of pieces defining a boundary of the block, the plurality of pieces comprising a current piece;
entropy decoding, from the encoded bitstream, a residual for the current piece of the block;
determining, for the current piece of the block using a processor, at least one of a first prediction piece or a second prediction piece, wherein the first prediction piece is determined based on a reference to a previously decoded piece, and the second prediction piece is determined based on solving a linear system associated with coefficients for the current piece and previously decoded pixels associated with a boundary of the current piece; and
determining a reconstructed piece for the current piece of the block based on the residual and the at least one of the first prediction piece or the second prediction piece.

2. The method of claim 1, wherein the block comprises a temporal dimension.

3. The method of claim 1, wherein the current piece is associated with one of: a corner pixel of the block, an edge of the block, or a face of the block.

4. The method of claim 1, wherein the plurality of pieces comprises corner pixels of the block, edges of the block, faces of the block, and the block.

5. The method of claim 1, further comprising:
determining, for the block, a decoding order for the plurality of pieces from the encoded bitstream.

6. The method of claim 1, further comprising:
decoding, from the encoded bitstream, the coefficients for the current piece.

7. The method of claim 1, further comprising:
determining, for the current piece, at least one of basis matrices or basis vectors, wherein the at least one of basis matrices or basis vectors is associated with the coefficients for the current piece for solving the linear system.

8. The method of claim 7, wherein determining, for the current piece, at least one of basis matrices or basis vectors, wherein the at least one of basis matrices or basis vectors is associated with the coefficients for the current piece for solving the linear system comprises:
selecting the at least one of basis matrices or basis vectors based on a size of the current piece.

9. The method of claim 7, wherein solving the linear system associated with coefficients for the current piece and previously decoded pixels associated with a boundary of the current piece comprises:
solving the linear system based on the at least one of basis matrices or basis vectors determined for the current piece, the coefficients for the current piece, and the previously decoded pixels associated with the boundary of the current piece.

10. A method for encoding video data, comprising:
determining, for a current piece of a block of the video data using a processor, at least one of a first prediction piece or a second prediction piece, the block having a plurality of pieces defining a boundary of the block, the plurality of pieces comprising the current piece, wherein the first prediction piece is determined based on a reference to a previously encoded piece of the video data, and the second prediction piece is determined based on solving a linear system associated with coefficients for the current piece and previously encoded pixels associated with a boundary of the current piece;
determining a residual for the current piece of the block based on the current piece and the at least one of the first prediction piece or the second prediction piece; and
entropy encoding the residual for the current piece of the block into a video bitstream.

11. The method of claim 10, wherein the block comprises a temporal dimension.

12. The method of claim 10, wherein the current piece is associated with one of: a corner pixel of the block, an edge of the block, or a face of the block.

13. The method of claim 10, wherein the plurality of pieces comprises corner pixels of the block, edges of the block, faces of the block, and the block.

14. The method of claim 10, further comprising:
determining, for the block, an encoding order for the plurality of pieces; and
encoding the encoding order into the video bitstream.

15. The method of claim 10, further comprising:
encoding the coefficients for the current piece into the video bitstream.

16. The method of claim 10, further comprising:
determining, for the current piece, at least one of basis matrices or basis vectors, wherein the at least one of basis matrices or basis vectors is associated with the coefficients for the current piece for solving the linear system.

17. The method of claim 16, wherein determining, for the current piece, at least one of basis matrices or basis vectors, wherein the at least one of basis matrices or basis vectors is associated with the coefficients for the current piece for solving the linear system comprises:
selecting the at least one of basis matrices or basis vectors based on a size of the current piece.

18. The method of claim 16, wherein solving the linear system associated with coefficients for the current piece and previously encoded pixels associated with a boundary of the current piece comprises:
solving the linear system based on the at least one of basis matrices or basis vectors determined for the current piece, the coefficients for the current piece, and the previously encoded pixels associated with the boundary of the current piece.

19. An apparatus for decoding a video bitstream, the apparatus comprising:
a non-transitory memory; and
a processor, wherein the non-transitory memory includes instructions executable by the processor to:
receive an encoded bitstream being representative of video data, the video data comprising a block having a temporal dimension and a plurality of pieces defining a boundary of the block, the plurality of pieces comprising a current piece;
entropy decode, from the encoded bitstream, a residual for the current piece of the block;
determine, for the current piece of the block, at least one of a first prediction piece or a second prediction piece, wherein the first prediction piece is determined based on a reference to a previously decoded piece, and the second prediction piece is determined based on solving a linear system associated with coefficients for the current piece and previously decoded pixels associated with a boundary of the current piece; and
determine a reconstructed piece for the current piece of the block based on the residual and the at least one of the first prediction piece or the second prediction piece.

20. The apparatus of claim 19, wherein the current piece is associated with one of: a corner pixel of the block, an edge of the block, a face of the block, and the block, and wherein the instructions executable by the processor further comprise instructions to:
decode, from the encoded bitstream, the coefficients for the current piece; and
determine, for the current piece, at least one of basis matrices or basis vectors, wherein the at least one of basis matrices or basis vectors is associated with the coefficients for the current piece for solving the linear system.
